(19) United States
(12) Patent Application Publication
(10) Pub. No.: US 2017/0249176 A1
(43) Pub. Date: Aug. 31, 2017

(54) SYSTEMS AND METHODS FOR CONFIGURATION KNOWLEDGE SEARCH

(71) Applicant: Red Hat, Inc., Raleigh, NC (US)

(72) Inventors: Filip Elias, Raleigh, NC (US); Filip Nguyen, Raleigh, NC (US)

(21) Appl. No.: 15/054,369

(22) Filed: Feb. 26, 2016

(51) Int. Cl. G06F 9/455; G06F 17/30

(52) U.S. Cl. CPC G06F 9/45558; G06F 17/30233; G06F 17/30548

(57) ABSTRACT

Various examples are directed to systems and methods for searching for possible configuration for software, for example, middleware. A computing device may collect and store user statistics of a configuration of the middleware in a designated database. The user statistics may be from users in a computing system. The computing device may collect the user statistics from users all over the world. The computing device may record a timeline of the configuration of the middleware in a call stack. The computing device may match search query terms with a corresponding component of the middleware in the call stack. The computing device may identify in the designated database a corresponding configuration of the corresponding component and propose a configuration to be made to the middleware based on the corresponding configuration of the corresponding component.

### BACKGROUND

Configuration knowledge search can be used in a number of different contexts to determine possible ways to configure software. Configuration knowledge search can be used to configure different software, including, for example, middleware. An application server may be an example of middleware. An administrator can determine where and/or how to configure the application server by performing configuration knowledge search.

### SUMMARY

Various examples are directed to systems and methods for searching for possible configuration for software, for example, middleware. A computing device may gather and store user statistics of a configuration of the middleware in a designated database. The user statistics may be from users in a computing system. The computing device may collect the user statistics from users all over the world. The computing device may trace the configuration of the middleware at runtime in a call stack. The computing device may match search query terms with a corresponding component of the middleware in the call stack. The computing device may identify in the designated database a corresponding configuration of the corresponding component and propose a configuration to be made to the middleware based on the corresponding configuration of the corresponding component.

### FIGURES

Various examples are described herein in conjunction with the following figures, wherein:

FIG. 1 is a high-level component diagram of an example computing device perform configuration knowledge search according to an example embodiment of the present disclosure.

FIG. 2 is a flow chart showing one example of a process flow that may be executed by the computing device of FIG. 1 to perform configuration knowledge search according to an example embodiment of the present disclosure.

FIG. 3 is a diagram showing examples of a tree plot, 3(a)-3(d) according to an example embodiment of the present disclosure.

FIG. 4 is a diagram showing an example of a computing system performing configuration knowledge search according to the process flow of FIG. 2 according to an example embodiment of the present disclosure.

### DETAILED DESCRIPTION OF EXAMPLE EMBODIMENTS

Various examples are directed to systems and methods for configuration knowledge search. Configuration knowledge search may include configuration identification and call stack gathering. A call stack may provide a timeline of configuration made to software.

In various examples, a computing device may perform configuration knowledge search by identifying configuration settings of a middleware being used by existing customers. This may be done globally for all the customers of the middleware. Also, configuration knowledge search may be performed for each specific instance of the middleware. The computing device may also monitor the middleware and records methods called, return values, and parameters of the middleware at runtime. In some examples, the computing device may receive a search query including search query terms based on a user input. By searching the search query terms, the computing device may provide possible configuration settings for the middleware.

Virtual machines are one example of an environment where the configuration knowledge search examples described herein may be used to find possible configuration settings for middleware. According to a virtual machine environment, a computing device (such as a server) may host multiple virtual machines. A software layer, often referred to as a hypervisor, runs on the server above the hardware layer and below the virtual machines. The hypervisor creates a virtualized hardware layer that is exposed to the virtual machines. This may provide some or all of the virtual machines with dedicated virtual hardware, such as virtual processors, data storage, network cards, etc. The hypervisor may implement the virtualized hardware layer using the underlying hardware of the computing device.

In various examples, middleware may run on virtual machines. Middleware may be computer software that provides services to software applications beyond those available from the operating system. Middleware can make it easier for software developers to perform communication and input/output, so the software developers can focus on the specific purpose of their application. Middleware may connect software components or enterprise applications. Middleware may be the software layer that lies between the operating system and the applications on each side of a distributed computer network. Middleware may support complex, distributed business software applications. On top of middleware may be user applications. Typically, the user applications must be fitted for the specific middleware. One example of middleware includes application servers that may dictate to customers that the applications must be in a specific format that complies with industry standards.

Middleware usually may be composites of different software modules that may not be originally designed to be integrated together. Each software module may be complex and hard to coordinate from different projects, so configuration of middleware may not be standardized. For example, for Java applications, there are not many standards for standardized components of the Java applications. The different modules can run independent of each other. A developer who creates a component may design its own way to configure a Java application. As a result, the Java application may contain separate software packages created by different developers or parties that may be complex on their own. With such a variety of these components, configuration is often quite hard. A person who needs to configure the Java applications may need to learn different configuration and/or different ways to configure different components. Some standards force companies to integrate these different components together and provide a unified configuration and runtime experience.

Configuration of large composite Java applications is a full-time job for a specialized administrator. A typical example of such a large composite application is an Application Server. The present disclosure leverages collective knowledge of specialized experts, and in a novel way, may advantageously increase productivity of administration of any such composite application.

In various examples, an administrator may encounter a problem (e.g., the application server is logging to the wrong file on a file system). The administrator may not know how or where to solve that problem. The administrator may know where the problem is, i.e., which component, but may not know where the configuration files of this component are. The administrator may not have examples of how to configure this component or the middleware.

The present disclosure ultimately may help administrators quickly build a system that will help them configure the application. In various examples, the administrator may use one aspect of this disclosure (e.g., Expert Query) by starting up a GUI app. The query process described herein may be referred to as “Expert Query.” The administrator may search for search query terms. The present disclosure may provide the administrator the best possible suggestion about where the middleware can be configured to fix the problem. In various examples, the administrator may be provided with examples of most difficult configuration values. The provided configuration values may include not only the location of the configuration setting, but also the typical configuration values that are usually set by other users in the world.

Reference will now be made in detail to various examples, several of which are illustrated in the accompanying figures. Wherever practical, similar or like reference numbers may be used in the figures and may indicate similar or like functionality. The figures depict examples of the disclosed systems (or methods) for purposes of illustration only. One skilled in the art will readily recognize from the following description that alternative examples of the structures and methods illustrated herein may be employed without departing from the principles described herein.

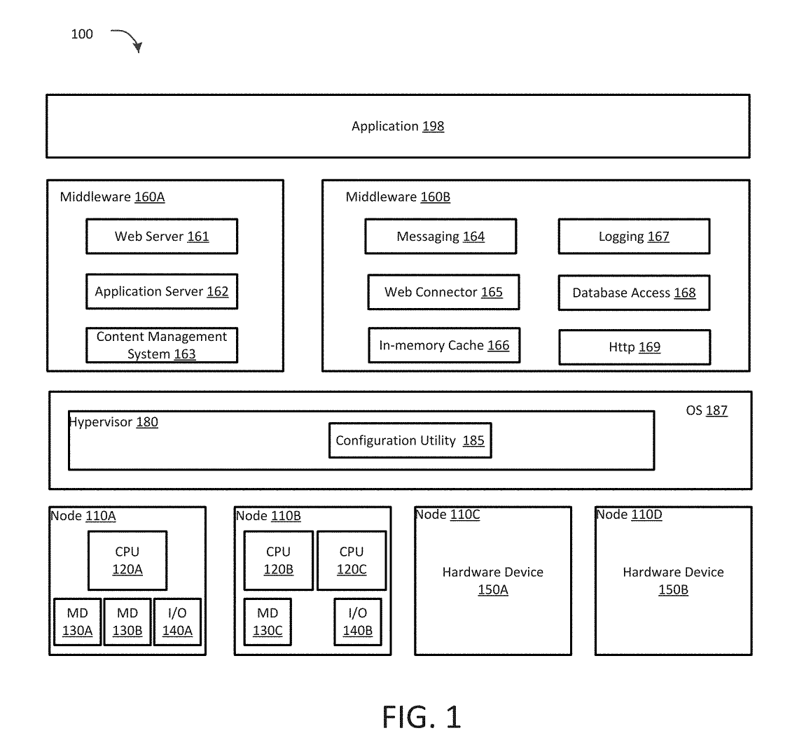

FIG. 1 is a high-level component diagram of an example computing device 100 performing configuration knowledge search as described herein. The computing device 100 may include one or more interconnected nodes 110A-D. Each node 110A-B may in turn include one or more physical processors (e.g., CPU 120A-C) communicatively coupled to memory devices (e.g., MD 130A-C) and input/output devices (e.g., I/O 140A-B). Each node 110C-D may include a hardware device 150A-B. In an example embodiment, a hardware device (e.g., 150A-B) may include a network device (e.g., a network interface controller (MC), a network adapter, or any other component that connects a computer to a computer network), a peripheral component interconnect (PCI) device, storage devices, sound or video adaptors, photo/video cameras, printer devices, keyboards, displays, etc. Memory devices 130A-C may include a volatile or non-volatile memory device, such as RAM, ROM, EEPROM, or any other device capable of storing data. As discussed herein, I/O devices 140A-B may include any device capable of providing an interface between one or more processor pins and an external device capable of inputting and/or outputting binary data.

Processors 120A-C may be interconnected using a variety of techniques, ranging from a point-to-point processor interconnect, to a system area network, such as an Ethernet-based network. Local connections within each node 110A-D, including the connections between a processor 120A and a memory device 130A-B and between a processor 120A and an I/O device 140A may be provided by one or more local buses of suitable architecture, for example, peripheral component interconnect (PCI). As used herein, a device of the host OS 186 (or “host device”) may refer to CPU 120A-C, MD 130A-C, I/O 140A-B, a software device, and/or hardware device 150A-B. Although the computing device 100 comprises multiple nodes 110A-D, some examples may omit one or more of the nodes 110A-D. Some examples, may utilize a single CPU, memory device, or I/O device.

The computing device 100 may run multiple virtual machines, by executing a software layer (e.g., hypervisor 180) above the hardware and below the virtual machines. In some examples, the hypervisor 180 may be a component of a host operating system (OS) executed by the computing device 100. In another example embodiment, the hypervisor 180 may be provided by an application running on the host OS, or may run directly on the computing device 100 without an operating system beneath it. The hypervisor 180 may virtualize the physical layer, including processors, memory, and I/O devices, and present this virtualization to virtual machines as devices, including virtual processors, virtual memory devices, and/or virtual I/O devices, etc.

In some examples, a virtual machine may execute a guest operating system which may utilize the underlying virtual processors, virtual memory devices, and virtual I/O devices. One or more applications 198 may be running on a virtual machine under the guest operating system. The virtual machine may include a device register. As used herein, a device register refers to a configuration space of a device. In an example embodiment, a device may be a device of a guest operating system (that is, a “guest device”). In an example embodiment, the device register is a guest device register. In an example embodiment, a device register may be a command register or a base address register (BAR). In an example embodiment, a device register may include any known register used in the peripheral component interconnect (PCI) configuration space. In an example embodiment, a base address register (BAR) includes a base (or start) address of the guest device at which a memory region of the host device (which corresponds to the guest device) can be accessed and further includes a size indicator which denotes the size of the memory region of the host device.

In some examples, a virtual machine may include multiple virtual processors. Processor virtualization may be implemented by the hypervisor 180 scheduling time slots on one or more physical processors 120A-C such that from the guest operating system's perspective those time slots are scheduled on a virtual processor. In some examples, a virtual machine may include virtual devices. A virtual device may provide the functionality of traditional hardware devices such as network devices, PCI devices, storage devices, sound or video adaptors, photo/video cameras, printer devices, keyboards, displays, etc.

In some examples, a middleware 160 or 160A-B may run on an operating system (OS) 187. In some examples, the OS 187 may be a host OS. In some other examples, the OS 187 may be a guest OS. The code that a middleware 160A-B runs on the OS may utilize the resources of the host OS, such as the memory devices 130A-C, and the input/output devices 140A-B as well as the resources of one or more of the virtual machines including the virtual processors, the virtual memory, and the virtual I/O devices. The middleware 160A-B may be integral to information technology based on Extensible Markup Language (XML), Simple Object Access Protocol (SOAP), Web services, SOA, Web 2.0 infrastructure, and Lightweight Directory Access Protocol (LDAP). In some examples, the middleware 160A-B may be a web server 161, an application server 162, a content management system 163, or other similar tools that support development and delivery of application 198. In some examples, the middleware 160A-B may be an Application Server for Java applications. One example may be Java Enterprise Edition. Java Enterprise Edition is a widely used enterprise computing platform developed under the Java Community Process. The platform may provide an API and runtime environment for developing and running enterprise software, including network and web services, and other large-scale, multi-tiered, scalable, reliable, and secure network applications. The platform may incorporate a design based largely on modular components running on an application server. Software for Java Enterprise Edition may be primarily developed in the Java programming language. Java Enterprise Edition may create packages with HTML files and different pieces of code written in Java programming language. The platform may deploy packages and/or applications to middleware. These packages and/or applications may be accessed by users through an http protocol. In some other examples, the middleware 160A-B may be Jboss implementation of application server—Jboss Enterprise Application Platform (EAP).

In some examples, the middleware 160A-B may include different components, for example, messaging 164, web connector 165, in-memory cache 166, logging 167, database access 168, and http 169. These components may not originally be designed to be integrated together. They can run independent of each other, but under some standards, such as Java Enterprise edition, these components have to be integrated together and have unified configuration and runtime experience. In some examples, the middleware 200A-B may include the component of logging 225. Logging 225 may be an easy way for a developer of the application 198 to trace what has been happening during operation of the application 198 in a log file. In some examples, the developer can find problems in the application 198 based on the log file.

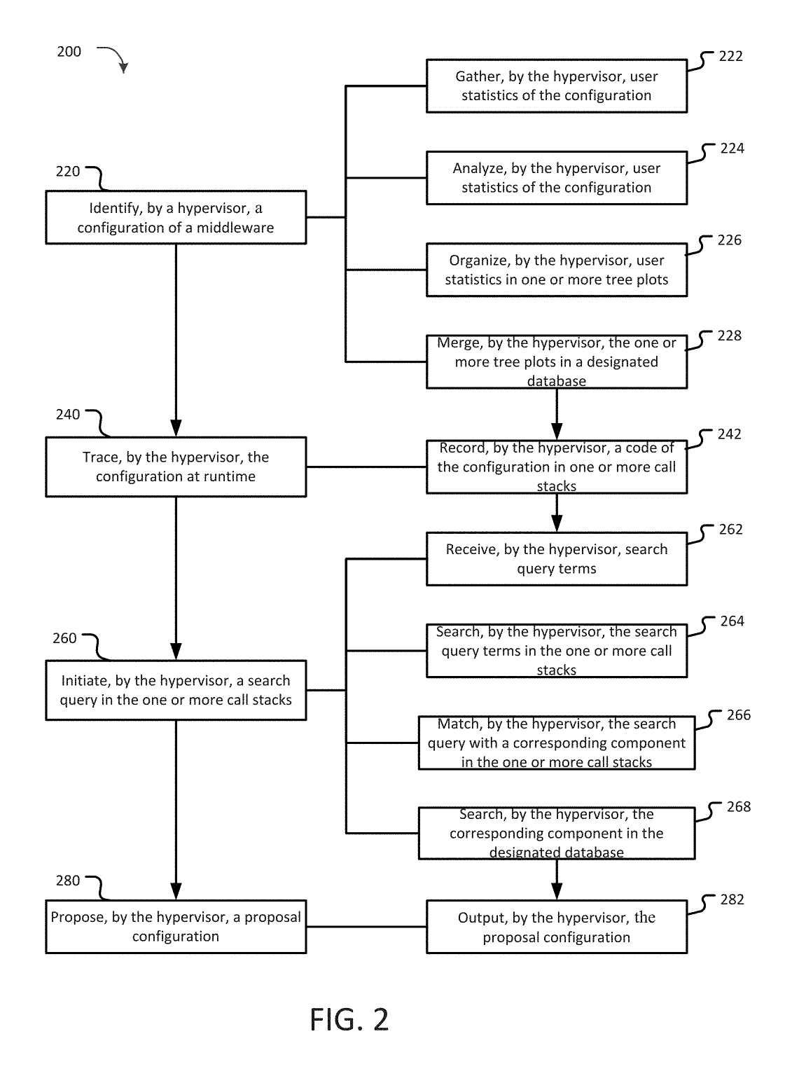

In an example embodiment, the hypervisor 180 may also comprise and/or utilize a configuration utility 185. The configuration utility 185 may search for possible configuration settings for the middleware 160A-B stored at one or more of the memory devices 130A-C utilizing configuration knowledge search, as described herein. For example, FIG. 2 is a flow chart showing one example of a process flow 200 that may be executed by the hypervisor 180 (e.g., the configuration utility 185) to perform configuration knowledge search for the middleware 160A-B. Although the example process flow 200 is described with reference to the flowchart illustrated in FIG. 2, it will be appreciated that many other methods of performing the acts associated with the process flow 200 may be used. For example, the order of some of the blocks may be changed, certain blocks may be combined with other blocks, and some of the blocks described are optional. The process flow 200 may be performed by processing logic that may comprise hardware (circuitry, dedicated logic, etc.), software, or a combination of both. The process flow 200 is described as executed by the hypervisor 180. For example, the process flow 200 may be executed by the configuration utility 185 or any other suitable component of the hypervisor 180 or OS187. The process flow 200, however, may be executed by any suitable component of the computing device 100 as well as any suitable computing device.

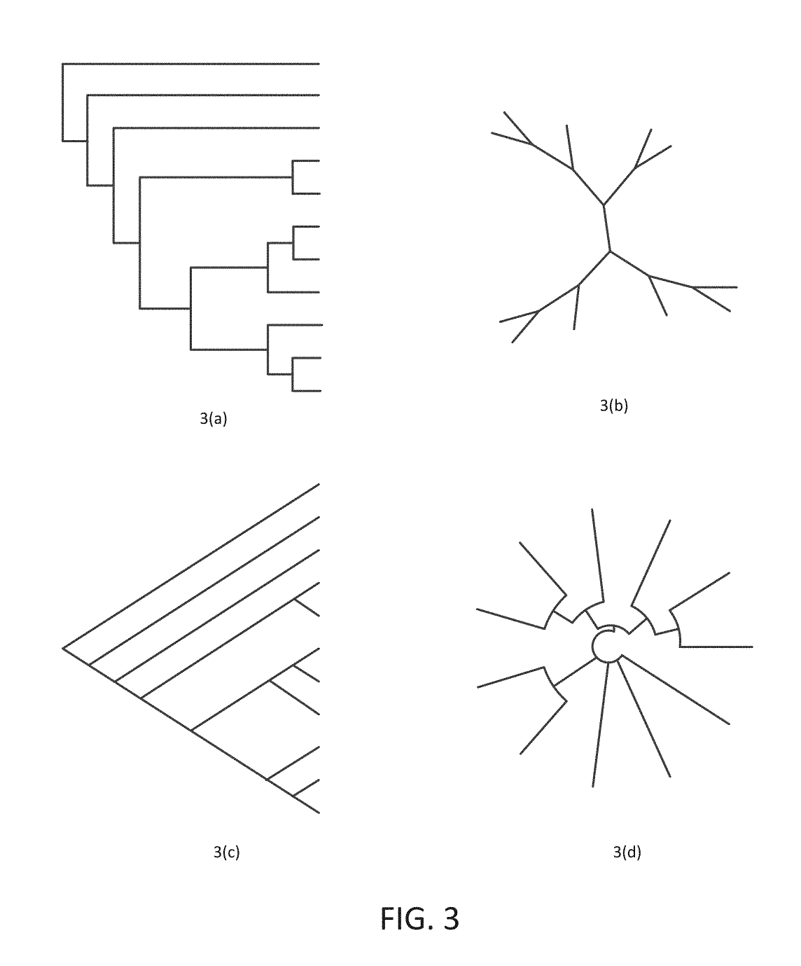

At block 220, the hypervisor 180 may perform configuration identification to identify a configuration of the middleware 160. The hypervisor 180 may identify changes to the configuration done by users. The configuration of the middleware 160 includes one or more ways to configure one or more components of the middleware 160. To identify a configuration of the middleware 160, the hypervisor 180 may gather user statistics of the configuration of the middleware 160 at 222. The hypervisor 180 may analyze the user statistics of the configuration of the middleware 160 at block 224. The user statistics may include configuration settings and may contain information such as which configuration file a user has modified and which database table the user has modified. Therefore, the user statistics may identify a configuration file modified by a user of the middleware 160 and may comprise data such as a location of the configuration file modified by the user, a key for the one or more components of the middleware 160, a configuration value, and/or combinations thereof. The location of the configuration file may be a path to the configuration file, a path to a file system where the configuration file is located, a path to a database where the configuration file is located, and/or combinations thereof. The key for the one or more components of the middleware 160 may be different for each component. The key may be a key in a property file, xml element name, xml attribute. In a database, the key may be a table and/or a column name. For example, the HTTP component 169 may have the location of the configuration file on a file system. The configuration file contains configuration for the HTTP component 169. The configuration file may contain different configurations. For the HTTP component 169, a first key may be the port, and a second key may be the string. The user can be any user and/or from anywhere in the world. The configuration value may be a value of the configuration supplied by the user. The configuration value may be a specific value that is being used and/or modified by the user. For example, the configuration value may be a path on a file system where user wants to store logging information. For the HTTP component 169, the configuration value may be a setting of the port where the user wants to publish a HTTP base. For example, a configuration value may be a URL. The hypervisor 180 may gather and analyze the user statistics from more than one user. In some examples, the hypervisor 180 may gather and analyze the user statistics from all users all over the world. At block 226, the hypervisor 180 may organize the user statistics in one or more tree plots. FIG. 3 shows some examples of the tree plot. The tree plot may be in various forms. The tree plot may be in a form of 3(a), 3(b), 3(c), 3(d), or any other suitable form of a tree plot. At block 228, the hypervisor 180 may merge the one or more tree plots of the user statistics in one designated database. The hypervisor 180 may store the tree plots of all users in the same database.

The hypervisor 180 may run the configuration identification continuously to identify changes to configuration done by users. The input may be running instances of the middleware 160. The users of the middleware 160, for example, the application server 162, may share usage information, for example, all the edits of made by the users to xml files, csv files, and other files of the application server 162 as well as internal databases used by the application server 162. Most of these edits may be edits to configuration files. The edits to the database edits may be also gathered because some components of the middleware 160 store their settings in databases. The longer the hypervisor 180 may perform the configuration identification, the more configuration settings the hypervisor 180 may gather, and the more users may be introduced to the gathering of the user statistics. The hypervisor 180 may output identified configuration settings for use in other steps of the process flow 200 as described herein.

At block 240, the hypervisor 180 may perform call stack gathering to trace the configuration at runtime. To trace the configuration at runtime, the hypervisor 180 may record the configuration of the middleware 160 at runtime in a call stack at block 242. The call stack may include a set of recordings of changes made to the code of the middleware 180 at runtime. The call stack may include a trace of the configuration of the middleware 160 at runtime. For example, the call stack may include a timeline of what has happened in the middleware 160 at the code level. The call stack may record actual calls to source code made during runtime. The call stack may show a log component and/or a property configuration of the middleware 160. The call stack may be created in the code of the virtual machines 170. For example, a call stack may include the following elements:
org.apache.log4j.PropertyConfigurator.configure(file/location/log 4j.properties)
Properties.load(“teiid-user.properties”);

This example call stack may show how the code progresses. In this example call stack, the 1og4j is a package for the class, property configuration. The next part of the call stack is configure. This configure part is the actual package that configures the component of which the configuration settings are being modified. The component of which the configuration has been modified may be identified according to the packages in the call stack. By inspecting the parameters in the call stack, for example, by looking at configure, locations of the tree plots with the actual components may be identified. The hypervisor 180 may record one or more call stacks.

At block 260, the hypervisor 180 performs an Expert Query by initiating a search query in the one or more call stacks. In some examples, a user of the middleware 160 may decide that some part of the middleware 160 is not configured properly. The user may decide that a component of the middleware 160 is not configured properly, and start a graphical user interface (GUI) application. The GUI application may provide a type of interface that allows the user to interact with electronic devices, such as the computing device 100, through graphical icons and visual indicators such as secondary notation, as opposed to text-based interfaces, typed command labels or text navigation. The GUI may use a combination of technologies and devices to provide a platform that the user can interact with. The GUI may include a combination of elements. Some examples of such a combination may be a WIMP (“window, icon, menu, pointing device”) paradigm. The WIMP style of interaction may use a virtual input device to control the position of a pointer, most often a mouse, and may present information organized in windows and represented with icons. Available commands may be compiled together in menus, and actions may be performed making gestures with the pointing device. A window manager may facilitate the interactions between windows, applications, and the windowing system. The windowing system may handle hardware devices such as pointing devices and graphics hardware, as well as the positioning of the pointer. In some examples, all these elements may be modeled through a desktop metaphor to produce a simulation called a desktop environment in which the display represents a desktop, upon which documents and folders of documents can be placed. Window managers and other software may combine to simulate the desktop environment with varying degrees of realism. The GUI application may request an Expert Query. The user may submit a search query. The search query may include one or more keywords or search query terms. The keyword or keywords may relate to the component that the user decides has a configuration error. The user may enter the keyword or keywords through the GUI application. The GUI application may run on the computing device 100. The GUI application may be executed by the virtual machines 170, and may utilize the resources of one or more of the virtual machines including the virtual processors, the virtual memory, and the virtual I/O devices as well as the resources of the host OS, such as the memory devices 130A-C, and the input/output devices 140A-B.

In a typical example, an administrator may be the user. The administrator may decide that an error has occurred in the middleware 160. In some examples, the administrator may decide that a problem exists in the application server 162 when logs of the application server 162 are being appended to a wrong file. For example, instead of file daily-log.txt, the log information is being appended into tmp/log.txt. In some examples, the administrator may decide that a problem exists in a web application when the web application uses wrong database to store its data. For example, instead of storing the data into Postgres database, it uses in-memory H2 database that ships with Application Server. In some examples, the administrator may decide that a problem exists in the web connector 165 for SSL when the web connector 165 is not turned on. For example, for some reason accessing https://localhost . . . does not work as expected. Thus, the administrator may start the GUI application. The GUI application may ask for an Expert Query. The administrator may enter the Expert Query. For example, for each of the above stated problems, the administrator may enter the following three Expert Queries: For the problem in the application server 162 when logs of the application server 162 are being appended to a wrong file, the administrator may enter search query terms such as “tmp, log.txt, append, info, logger.” For the problem that exists in the web application when the web application uses in-memory H2 database, the administrator may enter search query terms such as “h2, database, datasource.” For the problem in the web connector 165 for SSL when the web connector 165 is not turned on, the administrator may enter search query terms such as “ssl, security, https.”

At block 262, the hypervisor 180 may receive search query terms. At block 264, the hypervisor 180 may search the search query terms in the one or more call stacks. At block 266, the hypervisor 180 may match the search query terms with a corresponding component of the middleware 160 recorded in the one or more call stacks. As described herein, a code of a configuration setting of the corresponding component at runtime may be recorded in the one or more call stacks. Codes of modified configurations of different component of the middleware 160 at runtime may be recorded in the one or more call stacks. The hypervisor 180 may search the code or the codes for at least part of the search query. The hypervisor 180 may search for the one or more keywords in the search query in the code or the codes recorded in the one or more call stacks. For example, the hypervisor 180 may match at least part of the search query with part of a code. The matched code may show which component corresponds to the search query. The matched code may contain information of the corresponding component that has been configured. The matched code may include a line that has been called. A package in the line may show which component has been configured. In some examples described above, after the administrator has entered the search query terms including “tmp, log.txt, append, info, logger,” the hypervisor 180 may find a line in a code that has been called including a package showing logger. The hypervisor 180 may investigate further the logger component in the call stacks. The hypervisor 180 may find out that the logger component has been configured.

At block 268, the hypervisor 180 may search the corresponding component from the user statistics. The hypervisor 180 may search the corresponding component in the designated database. The hypervisor 180 may search the corresponding component in the tree plots. The hypervisor 180 may identify a corresponding configuration of the corresponding component. In some examples described above, the hypervisor 180 may find a specific configuration setting of the logger component that has been changed. The hypervisor 180 may identify more than one configuration settings of the corresponding component that have been modified. The corresponding component may have been configured by one user or more than one user. In some examples, the hypervisor 180 may identify several corresponding components in the one or more call stacks. After several corresponding components are identified, the one or more call stacks may be back-traced to find the configuration settings that affect these components.

In some examples of the logger component as described herein, the call stack may contain the following:
(1)
org.apache.log4j.PropertyConfigurator.configure(file/location/log 4j.properties)
(2)
org.apache.log4j.Logger.info( . . . )

Part (1) may be in early parts of the logger component. Part (2) may be near the place (chronologically) when the administrator enters the search query terms “tmp, log.txt, append, info, logger.” By performing the expert query, the hypervisor 180 may find line (2). Line (2) may be a call that has been called at some point in the middleware 160. Line (2) may also be part of the call stack. Line (2) may include additional information that can be used during Expert Query. From line (2), the hypervisor 180 may back-trace to find out that the logger component is being constructed and configured using (1) which may be paired with configuration settings of the logging subsystem. From this call stack, the hypervisor 180 may find out which configuration file has been used to configure this component. From this call stack, the hypervisor 180 may find out that this component has been configured from a specific location or at certain items at the specific location.

At block 280, the hypervisor 180 may propose a configuration proposal. The hypervisor 180 may output a proposal configuration based on the corresponding configuration of the corresponding component. The hypervisor 180 may propose more than one proposal configuration that can be made to the corresponding component. The hypervisor 180 may output different possibilities to configure specific keys in specific locations for one or more components. The hypervisor 180 may output one or more subsets of the one or more tree plots. In some examples of the logger component as described herein, the administrator may be proposed the configuration settings that correspond to the call stack as exampled above. Tables of the configuration settings may be outputted to the administrator. According to these proposed configuration settings, the administrator may modify the configuration to fix the logging problem.

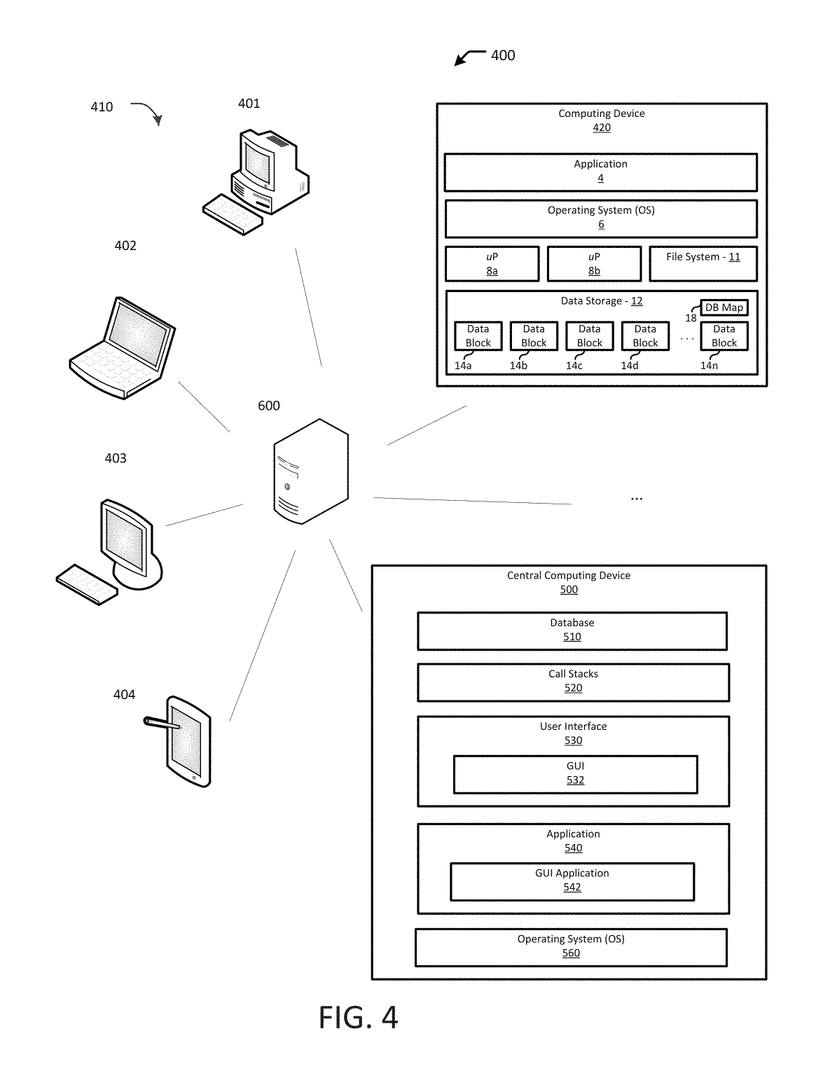

FIG. 4 is a diagram showing one example of a computing system 400 performing configuration knowledge search as described herein, for example, at FIG. 2. The computing system 400 may include one of a central computing device 500, a network 410 of user computing devices; a server 600, and combinations thereof. The network 410 of user computing devices may include user computing devices 401, 402, 403, 404, . . . . The network 410 of user computing devices may include computing devices of users from all over the world. The network of user computing devices may include computing devices of all the users in the world. Each of the computing devices in the computing system 400 may be a computing device 420. The computing device 420 may comprise various hardware including one or more processors 8a, 8b, and a data storage device 12. As used herein, processor or processors 8a, 8b may refer to a device capable of executing instructions encoding arithmetic, logical, and/or I/O operations. In some examples, a processor may follow the Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual processor dies are included in a single integrated circuit package and hence share a single socket). A processor may also be referred to as a central processing unit (CPU). The data storage device 12 may be any suitable type of data storage device including, for example, one or more disks, one or more solid state drives, random access memory (RAM), cache memory, etc. In some examples, the data storage device 12 may comprise multiple physical devices. In some examples, additional hardware may be included such as, for example, network adapters, various sensors, etc.

Above the hardware 8a, 8b, 12, an operating system 6 and file system 11 may provide an interface between one or more applications 4 and the hardware 8a, 8b, 12. For example, the application 4 may provide data requests to the operating system 6. Data requests may include any type of request to manipulate data (e.g., data stored at the data storage device 12). Example data requests include read requests and write requests. Data requests may include a logical name referring to one or more data blocks 14a, 14b, 14c, 14d, 14n to be read or written and an operation to be performed on the data block. When the data request is a write request, it may also include a data block or blocks to be written to the data storage device 12. The logical name, for example, may refer to a file, directory, etc., or other logical grouping, which may be defined by the file system 11 of the relevant data storage device 12. In some examples, the logical name may be a logical name of a data block or data blocks. The operating system 6 and/or the file system 11 may identify one or more of the data blocks 14a, 14b, 14c, 14d, 14n referenced by the logical name and perform the requested operation.

Data blocks 14a, 14b, 14c, 14d, may be units or blocks of data below the logical or file level. For example, logical constructs, such as files, directories, metadata, etc., may include one or more of the data blocks 14a, 14b, 14c, 14d, 14n. In some examples, data blocks are sized to correspond to the smallest unit of data handled by the data storage device 12, which may depend on the physical device or devices making up the data storage device 12 and/or the organization of the file system 11. In some examples, data blocks 14a, 14b, 14c, 14d, 14n may correspond to physical sectors at the data storage device 12 or its subcomponents. For example, some physical data storage devices use sectors that are 4 kilobytes. Some data storage devices may use slightly larger sectors, for example, including additional bytes that may be used for a checksum. Other example sector sizes include 512 bytes, 1024 bytes, etc. Accordingly, some examples may utilize data blocks 14a, 14b, 14c, 14d, 14n that are 512 bytes, 1024 bytes, 4 kilobytes, or any other suitable size. Also, in some examples, data blocks 14a, 14b, 14c, 14d, 14n may correspond to clusters of the file system 11. For example, a typical file system cluster may be 4096 bytes or 4 kilobytes (kB) and, some physical storage devices, such as CD-ROM's, have clusters that are 2048 bytes (2 kB). Accordingly, 4 kB and 2 kB data blocks may be used in some embodiments.

The central computing device 500 may comprise a database 510, call stacks 520, a user interface 530. The central computing device 500 may collect user statistics from the network of user computing devices through the server 600. The database 510 may be the designated database for storing the user statistics. The user statistics may be stored in the database 510 as one or more tree plots. The central computing device 500 may store in the call stacks 520 the set of recordings of configurations of the middleware 160 at runtime. The administrator may enter the Expert Query through the user interface 530. The configuration proposal may also be outputted through the user interface 530. The user interface 530 may be provided by the GUI application.

Aspects of the subject matter described herein may be useful alone or in combination with one or more other aspects described herein. Without limiting the following description, in a first example aspect of the present disclosure, a method for searching configuration knowledge of a middleware in a virtual machine environment may comprise identifying a configuration of the middleware by a hypervisor executing at a computing device and from a virtual machine executing at the computing device, the computing device comprising at least one processor and a data storage device in communication with the at least one processor, the middleware comprising at least one component, providing to a corresponding software application services not provided by the computing device, and supporting development and delivery of the corresponding software application, and the configuration of the middleware comprising a way to configure the at least one component, identifying the configuration comprising gathering, by the hypervisor, user statistics of the configuration of the middleware, the user statistics identifying a configuration file and comprising data selected from the group consisting of a location of the configuration file, a key for the at least one component of the middleware, and a configuration value, and combinations thereof, and storing, by the hypervisor, the user statistics in a designated database; tracing, by the hypervisor, the configuration at runtime, comprising recording, by the hypervisor, a code of the configuration of the middleware at runtime in a call stack; initiating, by the hypervisor, a search query, comprising matching, by the hypervisor, search query terms with a corresponding component of the middleware in the call stack; and identifying, by the hypervisor, in the designated database a corresponding configuration of the corresponding component; and proposing, by the hypervisor, a proposal configuration based on the corresponding configuration of the corresponding component. In accordance with another example aspect of the present disclosure, which may be used in combination with any one or more of the preceding aspects, the user statistics may be organized in a tree plot. In accordance with another example aspect of the present disclosure, which may be used in combination with any one or more of the preceding aspects, the proposal configuration may comprise a subset of the tree plot. In accordance with another example aspect of the present disclosure, which may be used in combination with any one or more of the preceding aspects, the designated database may comprise the user statistics for all users of the middleware. In accordance with another example aspect of the present disclosure, which may be used in combination with any one or more of the preceding aspects, the location of the configuration file may be selected from the group consisting of a path to the configuration file, a path to a file system where the configuration file is located, a path to a database where the configuration file is located, and combinations thereof. In accordance with another example aspect of the present disclosure, which may be used in combination with any one or more of the preceding aspects, the configuration file may comprise more than one configuration. In accordance with another example aspect of the present disclosure, which may be used in combination with any one or more of the preceding aspects, the call stack may comprise a set of recordings of the code of the configuration. In accordance with another example aspect of the present disclosure, which may be used in combination with any one or more of the preceding aspects, the search query may comprise at least one keyword. In accordance with another example aspect of the present disclosure, which may be used in combination with any one or more of the preceding aspects, initiating the search query may further comprise receiving the search query terms. In accordance with another example aspect of the present disclosure, which may be used in combination with any one or more of the preceding aspects, initiating the search query may further comprise searching the corresponding component in the designated database.

In a second example aspect of the present disclosure, a computer system for searching configuration knowledge may comprise at least one processor; a data storage device in communication with the at least one processor, wherein the data storage device comprises instructions that, when executed by the at least one processor, cause the at least one processor to: analyze user statistics of a configuration of a middleware, wherein the middleware comprises at least one component, the configuration of the middleware comprises a way to configure the at least one component, and the user statistics identifies a configuration file; merge the user statistics in a designated database; trace a code of the configuration of the middleware at runtime in a call stack; match search query terms with a corresponding component of the middleware in the call stack; search in the designated database a corresponding configuration of the corresponding component; and output a proposal configuration based on the corresponding configuration of the corresponding component. In accordance with another example aspect of the present disclosure, which may be used in combination with any one or more of the preceding aspects, the user statistics comprise data may be selected from the group consisting of a location of the configuration file, a key for the at least one component of the middleware, and a configuration value, and combinations thereof. In accordance with another example aspect of the present disclosure, which may be used in combination with any one or more of the preceding aspects, the data storage device further comprises instructions that, when executed by the at least one processor, cause the at least one processor to save the user statistics in at least one tree plot. In accordance with another example aspect of the present disclosure, which may be used in combination with any one or more of the preceding aspects, the computer system may further comprise at least one user interface. In accordance with another example aspect of the present disclosure, which may be used in combination with any one or more of the preceding aspects, the data storage device may further comprise instructions that, when executed by the at least one processor, cause the at least one processor to receive the search query terms. In accordance with another example aspect of the present disclosure, which may be used in combination with any one or more of the preceding aspects, the data storage device may further comprise instructions that, when executed by the at least one processor, cause the at least one processor to search the corresponding component in the designated database.

In a third example aspect of the present disclosure, a method may comprise collecting, by a computing device, user statistics of a configuration of a middleware, wherein the middleware comprises at least one component and provides to a corresponding software application services not provided by the computing device, the configuration of the middleware comprises a way to configure the at least one component, and the user statistics identifies a configuration file modified by a user of the middleware; saving, by the computing device, the user statistics in a designated database; storing, by the computing device, a code of the configuration of the middleware at runtime in a call stack; matching, by the computing device, search query terms with a corresponding component of the middleware in the call stack; finding, by the computing device, in the designated database a corresponding configuration of the corresponding component; and providing, by the computing device, a proposal configuration based on the corresponding configuration of the corresponding component in the designated database. In accordance with another example aspect of the present disclosure, which may be used in combination with any one or more of the preceding aspects, the user statistics may comprise data selected from the group consisting of a location of the configuration file, a key for the at least one component of the middleware, and a configuration value, and combinations thereof. In accordance with another example aspect of the present disclosure, which may be used in combination with any one or more of the preceding aspects, the method may further comprise organizing the user statistics in at least one tree plot. In accordance with another example aspect of the present disclosure, which may be used in combination with any one or more of the preceding aspects, the method may further comprise searching the corresponding component in the designated database.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

Reference in the specification to, “examples,” “various examples,” “some examples,” etc. means that a particular feature, structure, or characteristic described in connection with the example embodiments is included in at least one embodiment of the invention. The appearances of the above-referenced phrases in various places in the specification are not necessarily all referring to the same embodiment. Reference to embodiments is intended to disclose examples, rather than limit the claimed invention. While the invention has been particularly shown and described with reference to several embodiments, it will be understood by persons skilled in the relevant art that various changes in form and details can be made therein without departing from the spirit and scope of the invention.

It should be noted that the language used in the specification has been principally selected for readability and instructional purposes, and may not have been selected to delineate or circumscribe the inventive subject matter. Accordingly, the present disclosure is intended to be illustrative, but not limiting, of the scope of the invention.

It is to be understood that the figures and descriptions of example embodiments of the present disclosure have been simplified to illustrate elements that are relevant for a clear understanding of the present disclosure, while eliminating, for purposes of clarity, other elements, such as for example, details of system architecture. Those of ordinary skill in the art will recognize that these and other elements may be desirable for practice of various aspects of the present examples. However, because such elements are well known in the art, and because they do not facilitate a better understanding of the present disclosure, a discussion of such elements is not provided herein.

In some examples of the present methods and systems disclosed herein, a single component can be replaced by multiple components, and multiple components replaced by a single component, to perform a given command or commands. Except where such substitution would not be operative to practice the present methods and systems, such substitution is within the scope of the present disclosure. Examples presented herein, including operational examples, are intended to illustrate potential implementations of the present method and system examples. Such examples are intended primarily for purposes of illustration. No particular aspect or aspects of the example method, product, computer-readable media, and/or system examples described herein are intended to limit the scope of the present disclosure.

The various components described herein may be and/or are executed by any suitable type of computing device including, for example, desktop computers, laptop computers, mobile phones, palmtop computers, personal data assistants (PDAs), etc. As used herein, a “computer,” “computer system,” “computing device,” or “computing device,” “machine,” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for processing data for standalone application and/or over a networked medium or media. Computers and computer systems disclosed herein may include operatively associated memory for storing certain software applications used in obtaining, processing, storing, and/or communicating data. Such memory can be internal, external, remote, or local with respect to its operatively associated computer or computer system. Memory may also include any means for storing software or other instructions including, for example and without limitation, a hard disk, an optical disk, floppy disk, ROM (read-only memory), RAM (random-access memory), PROM (programmable ROM), EEPROM (extended erasable PROM), and/or other like computer-readable media.

Some portions of the above disclosure are presented in terms of methods and symbolic representations of operations on data bits within a computer memory. These descriptions and representations are the means used by those skilled in the art to most effectively convey the substance of their work to others skilled in the art. A method is here, and generally, conceived to be a sequence of actions (instructions) leading to a desired result. The actions are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times, to refer to certain arrangements of actions requiring physical manipulations of physical quantities as modules or code devices, without loss of generality. It should be borne in mind, however, that all of these and similar terms are to be associated with the appropriate physical quantities and are merely convenient labels applied to these quantities. Unless specifically stated otherwise as apparent from the preceding discussion, throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system memories or registers or other such information storage, transmission, or display devices.

Certain aspects of the present disclosure include process steps and instructions described herein in the form of a method. It should be noted that the process steps and instructions of the present disclosure can be embodied in software, firmware, or hardware, and when embodied in software, can be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random-access memories (RAMs), electrically-programmable read-only memories (EPROMs), electrically erasable programmable read-only memories (EEPROMs), magnetic or optical cards, application-specific integrated circuits (ASICs), or any type of media suitable for storing electronic instructions, and each coupled to a computer system bus. Furthermore, the computers and computer systems referred to in the specification may include a single processor or may be architectures employing multiple processor designs for increased computing capability.

The methods and systems presented herein, unless indicated otherwise, are not inherently related to any particular computer or other apparatus. Various general-purpose systems may also be used with programs in accordance with the teachings herein, or it may prove convenient to construct more specialized apparatus to perform the disclosed method actions. The structure for a variety of these systems will appear from the above description. In addition, although some of the examples herein are presented in the context of a particular programming language, the present disclosure is not limited to any particular programming language. A variety of programming languages may be used to implement the teachings of the present disclosure as described herein, and any references above to specific languages are provided for disclosure of enablement and best mode of the present disclosure.

The term “computer-readable medium” as used herein may include, for example, magnetic and optical memory devices such as diskettes, compact discs of both read-only and writeable varieties, optical disk drives, and hard disk drives. A computer-readable medium may also include non-transitory memory storage that can be physical or virtual.

What is claimed is:

1. A method for searching configuration knowledge of a middleware in a virtual machine environment, comprising:
identifying a configuration of the middleware by a hypervisor executing at a computing device and from a virtual machine executing at the computing device, the computing device comprising at least one processor and a data storage device in communication with the at least one processor, the middleware comprising at least one component, providing to a corresponding software application services not provided by the computing device, and supporting development and delivery of the corresponding software application, and the configuration of the middleware comprising a way to configure the at least one component, identifying the configuration comprising
gathering, by the hypervisor, user statistics of the configuration of the middleware, the user statistics identifying a configuration file and comprising data selected from the group consisting of a location of the configuration file, a key for the at least one component of the middleware, and a configuration value, and combinations thereof, and
storing, by the hypervisor, the user statistics in a designated database;
tracing, by the hypervisor, the configuration at runtime, comprising recording, by the hypervisor, a code of the configuration of the middleware at runtime in a call stack;
initiating, by the hypervisor, a search query, comprising
matching, by the hypervisor, search query terms with a corresponding component of the middleware in the call stack; and
identifying, by the hypervisor, in the designated database a corresponding configuration of the corresponding component; and
proposing, by the hypervisor, a proposal configuration based on the corresponding configuration of the corresponding component.

2. The method of claim 1, wherein the user statistics are organized in a tree plot.

3. The method of claims 2, wherein the proposal configuration comprises a subset of the tree plot.

4. The method of claim 1, wherein the designated database comprises the user statistics for all users of the middleware.

5. The method of claim 1, wherein the location of the configuration file is selected from the group consisting of a path to the configuration file, a path to a file system where the configuration file is located, a path to a database where the configuration file is located, and combinations thereof.

6. The method of claim 1, wherein the configuration file comprises more than one configuration.

7. The method of claims 1, wherein the call stack comprises a set of recordings of the code of the configuration.

8. The method of claims 1, wherein the search query terms comprise at least one keyword.

9. The method of claims 1, wherein initiating the search query further comprises receiving the search query terms.

10. The method of claim 1, wherein initiating the search query further comprises searching the corresponding component in the designated database.

11. A computer system for searching configuration knowledge, comprising:
at least one processor;
a data storage device in communication with the at least one processor, wherein the data storage device comprises instructions that, when executed by the at least one processor, cause the at least one processor to:
analyze user statistics of a configuration of a middleware, wherein the middleware comprises at least one component, the configuration of the middleware comprises a way to configure the at least one component, and the user statistics identifies a configuration file;
merge the user statistics in a designated database;
trace a code of the configuration of the middleware at runtime in a call stack;
match search query terms with a corresponding component of the middleware in the call stack;
search in the designated database a corresponding configuration of the corresponding component; and
output a proposal configuration based on the corresponding configuration of the corresponding component.

12. The computer system of claim 11, wherein the user statistics comprise data selected from the group consisting of a location of the configuration file, a key for the at least one component of the middleware, and a configuration value, and combinations thereof

13. The computer system of claim 11, wherein the data storage device further comprises instructions that, when executed by the at least one processor, cause the at least one processor to save the user statistics in at least one tree plot.

14. The computer system of claim 11, further comprising at least one user interface.

15. The computer system of claim 11, wherein the data storage device further comprises instructions that, when executed by the at least one processor, cause the at least one processor to receive the search query terms.

16. The computer system of claim 11, wherein the data storage device further comprises instructions that, when executed by the at least one processor, cause the at least one processor to search the corresponding component in the designated database.

17. A method, comprising:
collecting, by a computing device, user statistics of a configuration of a middleware, wherein the middleware comprises at least one component and provides to a corresponding software application services not provided by the computing device, the configuration of the middleware comprises a way to configure the at least one component, and the user statistics identifies a configuration file modified by a user of the middleware;
saving, by the computing device, the user statistics in a designated database;
storing, by the computing device, a code of the configuration of the middleware at runtime in a call stack;
matching, by the computing device, search query terms with a corresponding component of the middleware in the call stack;
finding, by the computing device, in the designated database a corresponding configuration of the corresponding component; and
providing, by the computing device, a proposal configuration based on the corresponding configuration of the corresponding component in the designated database.

18. The method of claim 17, wherein the user statistics comprise data selected from the group consisting of a location of the configuration file, a key for the at least one component of the middleware, and a configuration value, and combinations thereof.

19. The method of claim 17, further comprising organizing the user statistics in at least one tree plot.

20. The method of claim 17, further comprising searching the corresponding component in the designated database.
